(19) United States
(12) Patent Application Publication
(10) Pub. No.: US 2023/0289660 A1
(43) Pub. Date: Sep. 14, 2023

(54) DATA PROCESSING METHOD AND ELECTRONIC DEVICE

(71) Applicant: NEC CORPORATION, Tokyo (JP)

(72) Inventors: Jian SHI, Beijing (CN); Ni Zhang, Beijing (CN)

(73) Assignee: NEC CORPORATION, Tokyo (JP)

(21) Appl. No.: 18/179,778

(22) Filed: Mar. 7, 2023

(30) Foreign Application Priority Data
Mar. 8, 2022 (CN) 202210220827.8

(51) Int. Cl. G06N 20/00; G06N 3/0475

(52) U.S. Cl. CPC G06N 20/00; G06N 3/0475

(57) ABSTRACT

Embodiments of the present disclosure relate to a data processing method and an electronic device, and relate to a field of computers. The method comprises: obtaining data to be detected; and determining an attribute of the data to be detected using a trained anomaly detection model, where the attribute indicates whether the data to be detected is anomalous data, where the anomaly detection model is trained based on a difference between a reconstructed data item and a normal data item and a difference between a first output data item and the reconstructed data item, where during training, the normal data item is input into a generative sub-model of the anomaly detection model to obtain the reconstructed data item, and the reconstructed data item is input into the generative sub-model to obtain the first output data item. In this way, in the solutions in the embodiments of the present disclosure, contextual adversarial information can be learnt, so that the trained anomaly detection model has a higher precision and a higher recall rate.

### FIELD

Embodiments of the present disclosure mainly relate to a field of computers, and more specifically, to a data processing method, a model training method, an electronic device, a computer-readable storage medium, and a computer program product.

### BACKGROUND

Anomaly detection aims at detecting exceptional data instances that significantly deviated from the normality data distributions. Anomaly detection has been widely used in medical diagnosis, fraud detection, structural defects and many other fields. Since supervised anomaly detection models require a large amount of labeled training data and are costly, currently commonly-used anomaly detection models are obtained in an unsupervised, semi-supervised, or weakly-supervised manner.

However, the current anomaly detection model will detect a lot of normal data as anomalous, and detect some real but complex anomalous data as normal. Therefore, the current anomaly detection model has a problem of low recall rate. In particular, in the case of scarce samples of anomaly data, the recall rate of an anomaly detection model may be lower, which is undesirable.

### SUMMARY

Exemplary embodiments of the present disclosure provide a solution for data processing, where a trained anomaly detection model can be used to determine whether data to be detected is anomalous.

According to a first aspect of the present disclosure, there is provided a data processing method, comprising: obtaining data to be detected; and determining an attribute of the data to be detected using a trained anomaly detection model, the attribute indicating whether the data to be detected is anomalous data, wherein the anomaly detection model is trained based on a difference between a reconstructed data item and a normal data item and a difference between a first output data item and the reconstructed data item, wherein during training, the normal data item is input into a generative sub-model of the anomaly detection model to obtain the reconstructed data item, and the reconstructed data item is input into the generative sub-model to obtain the first output data item.

According to a second aspect of the present disclosure, there is provided a method of training an anomaly detection model, comprising: inputting a normal data item in a training set into a generative sub-model of the anomaly detection model to obtain a reconstructed data item; inputting the reconstructed data item into the generative sub-model to obtain a first output data item; and training the anomaly detection model based on a difference between the reconstructed data item and the normal data item and a difference between the first output data item and the reconstructed data item.

According to a third aspect of the present disclosure, there is provided an electronic device, comprising: at least one processing unit; and at least one memory being coupled to the at least one processing unit and configured to store instructions for being executed by the at least one processing unit, the instructions, when executed by the at least one processing unit, causing the device to perform actions comprising: obtaining data to be detected; and determining an attribute of the data to be detected using a trained anomaly detection model, the attribute indicating whether the data to be detected is anomalous data, wherein the anomaly detection model is trained based on a difference between a reconstructed data item and a normal data item and a difference between a first output data item and the reconstructed data item, wherein during training, the normal data item is input into a generative sub-model of the anomaly detection model to obtain the reconstructed data item, and the reconstructed data item is input into the generative sub-model to obtain the first output data item.

According to a fourth aspect of the present disclosure, there is provided an electronic device, comprising: at least one processing unit; and at least one memory being coupled to the at least one processing unit and configured to store instructions for being executed by the at least one processing unit, the instructions, when executed by the at least one processing unit, causing the device to perform actions comprising: inputting a normal data item in a training set into a generative sub-model of the anomaly detection model to obtain a reconstructed data item; inputting the reconstructed data item into the generative sub-model to obtain a first output data item; and training the anomaly detection model based on a difference between the reconstructed data item and the normal data item and a difference between the first output data item and the reconstructed data item.

According to a fifth aspect of the present disclosure, there is provided an electronic device, comprising: a memory and a processor; wherein the memory is configured to store one or more computer instructions, wherein the one or more computer instructions are executed by the processor to perform the method described according to the first or second aspect of the present disclosure.

According to a sixth aspect of the present disclosure, there is provided a computer readable storage medium having machine-executable instructions stored thereon, the machine-executable instructions, when executed by a device, cause the device to perform the method described according to the first or second aspect of the present disclosure.

According to a seventh aspect of the present disclosure, there is provided a computer program product comprising computer-executable instructions, the computer-executable instructions, when executed by a processor, implement the method described according to the first or second aspect of the present disclosure.

According to an eighth aspect of the present disclosure, there is provided an electronic device, comprising a processing circuitry apparatus configured to perform the method described according to the first or second aspect of the present disclosure.

The Summary is to introduce a series of concepts in a simplified form which will be further described in the Detailed Description. The Summary is not intended to identify key features or essential features of the present disclosure, nor is it intended to be used to limit the scope of the present disclosure. Other features of the present disclosure will be made apparent by the following depictions.

### BRIEF DESCRIPTION OF THE DRAWINGS

The above and other features, advantages and aspects of the present disclosure will become more apparent through the detailed description below with reference to the accompanying drawings. Throughout the drawings, same or similar reference numerals represent same or similar elements, wherein:

FIG. 1 illustrates a block diagram of an example environment according to embodiments of the present disclosure;

FIG. 2 illustrates a flow chart of an example training process according to embodiments of the present disclosure;

FIG. 3 illustrates a schematic diagram of a training process based on normal data items according to embodiments of the present disclosure;

FIG. 4 illustrates a schematic diagram of a training process based on anomalous data items according to embodiments of the present disclosure;

FIG. 5 illustrates a flowchart of an example usage process according to embodiments of the present disclosure;

FIG. 6 illustrates a schematic diagram of a result of anomaly detection according to embodiments of the present disclosure;

FIG. 7 illustrates a schematic diagram of a result of anomaly detection according to embodiments of the present disclosure; and

FIG. 8 illustrates a block diagram of an example device that may be used to implement embodiments of the present disclosure.

### DETAILED DESCRIPTION OF EMBODIMENTS

Hereinafter, embodiments of the present disclosure will be described in more detail with reference to the accompanying drawings. Although the drawings illustrate some embodiments of the present disclosure, it is to be understood that the present disclosure can be implemented in various ways, and the illustrated embodiments should not be construed as being limited to the embodiments set forth herein. On the contrary, these embodiments are provided to enable a more thorough and complete understanding of the present disclosure. It is to be appreciated that the drawings and embodiments of the present disclosure are only used for exemplary purposes, and are not intended to limit the protection scope of the present disclosure.

As used herein, the term “comprises” and its equivalents are to be read as open terms that mean “comprises, but is not limited to.” The term “based on” is to be read as “based at least in part on.” The terms “one embodiment” or “the embodiment” is to be read as “at least one example embodiment.” The term “first,” “second,” and the like may refer to different or the same objects. Other definitions, either explicit or implicit, may be included below.

Various methods and processes described in the embodiments of the present disclosure may also be applied to various kinds of electronic devices, e.g., terminal devices, network devices, etc. The embodiments of the present disclosure may also be executed in a test device, such as a signal generator, a signal analyzer, a spectrum analyzer, a network analyzer, a test terminal device, a test network device, and a channel simulator, etc.

The term “circuitry” used herein may refer to hardware circuits and/or combinations of hardware circuits and software. For example, the circuitry may be a combination of analog and/or digital hardware circuits with software/firmware. As an alternative example, the circuitry may be any portions of hardware processors with software including digital signal processor(s), software, and memory(ies) that work together to cause an apparatus, such as a computing device and the like, to perform various functions. In a still further example, the circuitry may be hardware circuits or processors, such as a microprocessor or a portion of a microprocessor, that requires software/firmware for operation, but the software may not be present when it is not needed for operation. As used herein, the term “circuitry” also covers implementation of merely a hardware circuit or processor(s), or a fraction of a hardware circuit or processor(s) in conjunction with the software and/or firmware affixed thereto.

Anomaly detection, also known as outlier detection, novelty detection, out-of-distribution detection, noise detection, deviation detection, exception detection, or other names, is an important technical branch in machine learning, is widely used in various applications involving artificial intelligence (AI), such as computer vision, data mining, natural language processing, etc. Anomaly detection may be understood as a technique for identifying anomalous situations and mining illogical data, which aims to detect exceptional data instances that significantly deviated from the normality data distributions.

Anomaly detection has been widely used in many fields such as medical diagnosis, fraud detection, and structural defects. For example, a doctor may be assisted in diagnosis and treatment by detecting whether medical images are anomalous data. For example, whether there is a telecommunications fraud can be determined by detecting whether the data corresponding to a bank card swiping behavior is anomalous data. For example, whether a driver has a behavior against traffic rules can be determined by detecting whether there is anomalous data in traffic surveillance video. An algorithm for anomaly detection may generally include a supervised anomaly detection method and an unsupervised anomaly detection method.

Supervised anomaly detection was mostly formulated as an imbalanced classification problem through different classification approaches and sampling strategies. A training set on which the supervised anomaly detection method is based comprises labeled data items. However, considering the lack of labels or the pollution of some data items, there is also a semi-supervised anomaly detection method to solve anomaly detection under little labeled or polluted data. For example, Deep Supervised Anomaly Detection (Deep-SAD) proposes a two-stage training with an information-theoretic framework.

Due to the scarcity and variety of anomaly data, the unsupervised anomaly detection method gradually began to be a dominant method for anomaly detection. For example, in an algorithm of Unsupervised Anomaly Detection with Generative Adversarial Networks (AnoGAN), a Generative Adversarial Network (GAN) is used for anomaly detection. The algorithm uses GAN to learn the distribution of normal data and attempts to reconstruct the most similar images by optimizing a latent noise vector iteratively.

However, the current anomaly detection method has the problem of low recall rate, and will detect a lot of normal data as anomalous, and detect some real but complex anomalous data as normal.

In view of this, embodiments of the present disclosure provide a data processing solution to solve one or more of the above-mentioned problems and/or other potential problems. In this solution, normal data or anomalous data may be used to obtain a trained anomaly detection model through training based on reconstruction. This model can generate contextual adversarial data based on normal data, and can perform supervised learning based on anomalous data. Thus the model can be used for anomaly detection with a high recall rate.

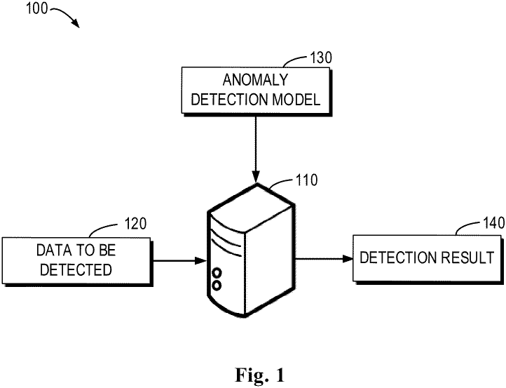

FIG. 1 illustrates a block diagram of an example environment 100 according to embodiments of the present disclosure. It should be appreciated that the environment 100 illustrated in FIG. 1 is only an example in which some embodiments of the present disclosure can be implemented, not intended for limiting the scope of the present disclosure. The embodiments of the present disclosure are also suitable for other systems or architectures.

As illustrated in FIG. 1, the environment 100 may comprise a computing device 110. The computing device 110 may be any device with computing capabilities. The computing device 110 may include, but not limited to, a personal computer, a server computer, a portable or laptop device, a mobile device (e.g., a mobile phone, a personal digital assistant (PDA), a media player, etc.), a wearable device, a consumer electronic product, a mini computer, a main frame, a distributed computing system, and a cloud computing resource, etc. It is understood that based on considerations of factors such as costs, the computing device 110 may have or do not have sufficient computing resources for model training.

The computing device 110 may be configured to acquire data to be detected 120, and output a detection result 140. A determination of the detection result 140 can be implemented by a trained anomaly detection model 130.

The data to be detected 120 may be input by a user, or may be acquired from a storage device, which is not limited in the present disclosure.

The data to be detected 120 may be determined based on actual needs, and the data to be detected 120 may be of various types, which is not limited in the present disclosure. Exemplarily, the data to be detected 120 may belong to any of the following categories: audio data, Electro Cardio Graph (ECG) data, Electro Encephalo Graph (EEG) data, image data, video data, point cloud data, or volume or volumetric data. Optionally, the volume data may be, for example, Computer Tomography (CT) data or Optical Computer Tomography (OCT) data.

As another understanding, the data to be detected 120 may be one-dimensional data, such as bioelectric signals such as audio, ECG data, or EEG data. The data to be detected 120 may be 2-dimensional data, such as an image. The data to be detected 120 may be 2.5-dimensional data, such as video. The data to be detected 120 may be 3D data, such as video, volume data such as CT and OCT data, and the like. It may be understood that the description of the type of the data to be detected 120 in the present disclosure is only for illustration, and in actual scenarios, the data to be detected 120 may also be any of other types, which is not limited in the present disclosure.

The detection result 140 may represent an attribute of the data to be detected 120, specifically may indicate whether the data to be detected 120 is anomalous data.

In some examples, the embodiments of the present disclosure may be applied to various fields. For example, the embodiments of the present disclosure may be applied in the medical field, and the data to be detected 120 may be ECG data, EGG data, CT data, OCT data, etc. It should be understood that the scenarios listed here are for illustrative purposes only and are not intended to limit the scope of the present invention in any way. Embodiments of the present disclosure may be applied to various fields with similar problems, which will not be listed herein. In addition, “detection” in the embodiments of the present disclosure may also be referred to as “recognition”, etc., which is not limited in the present disclosure.

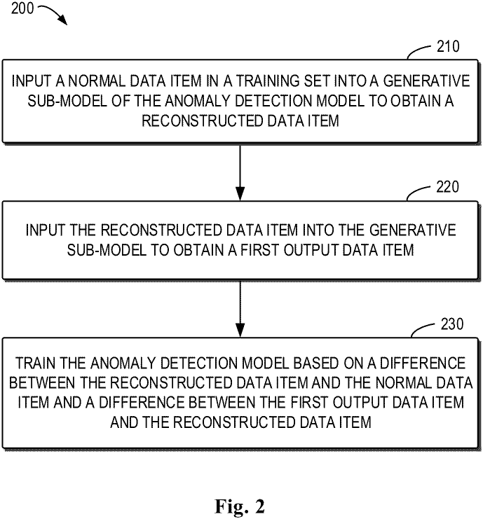

In some embodiments, the anomaly detection model 130 may be trained before implementing the process described above. It should be understood that anomaly detection model 130 may be trained by the computing device 110 or by any other suitable device external to the computing device 110. The trained anomaly detection model 130 may be deployed in the computing device 110 or may be deployed external to the computing device 110. An example training process will be described below with reference to FIG. 2 by taking the computing device 110 to train the anomaly detection model 130 as an example.

FIG. 2 illustrates a flow chart of an example training process 200 according to embodiments of the present disclosure. For example, the method 200 may be performed by the computing device 110 as shown in FIG. 1. It should be understood that method 200 may also include additional blocks not shown and/or some blocks shown may be omitted. The scope of the present disclosure is not limited in this respect.

At block 210, a normal data item in a training set is input into a generative sub-model of an anomaly detection model to obtain a reconstructed data item.

At block 220, the reconstructed data item is input into the generative sub-model to obtain a first output data item.

At block 230, an anomaly detection model is trained based on a difference between the reconstructed data item and the normal data item and a difference between the first output data item and the reconstructed data item.

It may be understood that before block 210 shown in FIG. 2, the method may further comprises: obtaining a training set comprising a plurality of data items, and any data item in the plurality of data items may be a normal data item or an anomalous data item. Then, correspondingly, blocks 210 to 230 shown in FIG. 2 may be understood as generating a trained anomaly detection model based on the training set.

As an example, the training set may be denoted as X, and any data item in the training set may be denoted as x, then X = {x: x~pₓ}. Optionally, in some examples, each data item in the training set is a normal data item. Optionally, in some examples, each data item in the training set is an anomalous data item. Optionally, in some examples, a part of the data items in the training set are normal data items, and a remaining part of the data items are anomalous data items. It should be appreciated that the term “data item” in the embodiments of the present disclosure may be replaced with “data” in some scenarios.

In embodiments of the present disclosure, a set in which the data items are all normal data items may be represented as a normal training set Xₙ, Xₙ = {xₙ:x_{n∼}pₓ,}, and a set in which the data items are all anomalous data items may be represented as an anomalous training set Xₐ = {xₐ: xₐ~_{Pxa}}. That is, the training set at block 210 may be denoted as X and include Xₙ and/or Xₐ.

Optionally, in some examples, Xₙ comprises a plurality of (e.g., N1) normal data items, Xₐ comprises a plurality of (e.g., N2) anomalous data items, N1 and N2 are positive integers, and generally N1 is much larger than N2, e.g., N1 is more than ten thousand times N2. It should be appreciated that the depiction of N1 and N2 here is only illustrative, for example, in some scenarios, N1 is smaller than N2. This is not limited in the present disclosure.

It may be appreciated that the embodiments of the present disclosure do not limit the types of data items in the training set. For example, training may be performed respectively for different types of training sets to obtain anomaly detection models that can be applied to different types of data.

As an example, the data items in the training set may be ECG data. Then the anomaly detection model obtained through the training set may be used to detect whether the input into the model is normal ECG data.

Exemplarily, in the embodiments of the present disclosure, a first loss function may be constructed based on a difference between the reconstructed data item and the normal data item and a difference between the first output data item and the reconstructed data item, where the first loss function comprises a first sub-function and a second sub-function, the first sub-function is obtained based on the difference between the reconstructed data item and the normal data item, and the second sub-function is obtained based on the difference between the first output data item and the reconstructed data item; and the anomaly detection model is trained based on the first loss function, where training objectives of the first sub-function and the second sub-function are opposite.

In some embodiments of the present disclosure, the anomaly detection model may comprise a generative sub-model and a discriminative sub-model, where the generative sub-model may be used to reconstruct based on the input data, and the discriminative sub-model may be used to determine whether the data reconstructed by the generative sub-model is true. That is, the discriminative sub-model may be used to determine whether the reconstructed data item obtained by the generative sub-model at block 210 is true or false.

Optionally, the generative sub-model may also be referred to as a generator, denoted as G for example. Optionally, the discriminative sub-model may also be referred to as a discriminator, denoted as D for example.

Exemplarily, the first sub-function may be obtained based on the difference between the reconstructed data item and the normal data item, for example, the first sub-function is represented as F_{dist} (Xₙ, X̅ₙ), where X̅ₙ represents a set of reconstructed data items. The second sub-function may be obtained based on the difference between the first output data item and the reconstructed data item, for example, the second sub-function is represented as F_{dist}(X̅_{n,} G(X̅ₙ)).

Moreover, during the training process, the training objectives of the first sub-function and the second sub-function are opposite, for example, the first sub-function may be expected to be a minimum (min), while the second sub-function may be expected to be a maximum (max), and a hyperparameter in the model may be obtained by learning on the basis of the training objective, as denoted by the following Equations (1) and (2):

$$min {F}_{d i s t} \left({X}_{n} , {\hat{X}}_{n} ; {θ}_{G}\right) \hat{} max {F}_{d i s t} \left({\hat{X}}_{n} , G \left({\hat{X}}_{n}\right) ; {θ}_{G}\right) \qquad \text{(1)}$$

$${min}_{G} {max}_{D} \left[log D \left({X}_{n} ; {θ}_{D}\right) + log \left(1 - D \left(G \left({X}_{n} ; {θ}_{G}\right) ; {θ}_{D}\right)\right)\right] \qquad \text{(2)}$$

In Equations (1) and (2), Λ represents “and”, log represents a natural logarithm, θ_{G} represents a hyperparameter for the generative sub-model G in the model, and θ_{D} represents a hyperparameter for the discriminative sub-model D in the model. Furthermore, it may be understood that in Equation (2),

$${min}_{G} {max}_{D}$$

means training the generative sub-model G and the discriminative sub-model D in an adversarial manner, for example, the generative sub-model G may be fixed to train the discriminative sub-model D, and the discriminative sub-model D may be fixed to train the generative sub-model G.

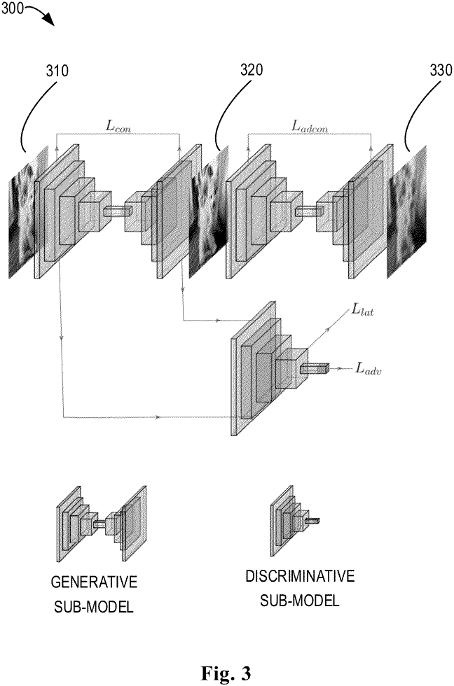

FIG. 3 illustrates a schematic diagram of a training process based on normal data items according to embodiments of the present disclosure.

As shown in FIG. 3, a normal data item 310 is input into the generative sub-model to obtain a reconstructed data item 320. The reconstructed data item 320 is input into the generative sub-model to obtain an output data item 330. For illustration, the type of normal data item 310 shown in FIG. 3 is an image, and correspondingly, the reconstructed data item 320 and the output data item 330 are also images. However, it should be understood that the image shown in FIG. 3 is only for illustration, and the present disclosure is not limited thereto.

Optionally, the generative sub-model may comprise an encoder and a decoder. As shown in FIG. 3, the normal data item 310 is input into the encoder, an output of the encoder is input into the decoder, and an output of the decoder is the reconstructed data item 320. As shown in FIG. 3, the reconstructed data item 320 is input into the encoder, the output of the encoder is input into the decoder, and the output of the decoder is the output data item 330. However, it should be appreciated that on the basis of data reconstruction, the generative sub-model may have other structures, and the present disclosure does not limit the structure of the generative sub-model.

The anomaly detection model may be trained based on the training set of normal data items and based on the first loss function, for example, the first loss function may be represented as Lₙ. Exemplarily, a contextual loss function represented as L_{con} may be determined based on the first sub-function, so as to make the reconstructed data item closer to the input normal data item, that is, try not to lose contextual information of the normal data item. Exemplarily, a contextual adversarial loss function represented as L_{adcon} may be determined based on the second sub-function.

In some embodiments, in order to ensure that the reconstructed data item generated by the generative sub-model G is true, an adversarial loss function may also be determined, denoted as L_{adv}, thereby increasing robustness. Additionally, a Latent Loss function, denoted as Lₗₐₜ, may also be determined to ensure the solid reconstruction of latent representations.

Exemplarily, the first loss function Lₙ may be represented as a weighted sum of the contextual loss function L_{con}, the contextual adversarial loss function L_{adcon}, the adversarial loss function L_{adv}, and the latent loss function Lₗₐₜ, as shown in the following Equations (3) to (7).

$${L}_{c o n} = {E}_{x \sim {p}_{x}} {\left|x - \hat{x}\right|}_{1} \qquad \text{(3)}$$

$${L}_{a d v} = {E}_{x \sim {p}_{x}} \left[l o g D \left(x\right)\right] + {E}_{x \sim {p}_{x}} \left[l o g D \left(x\right)\right] \qquad \text{(4)}$$

$${L}_{l a t} = {E}_{x \sim {p}_{x}} {\left|{D}_{Z} \left(x\right) - {D}_{Z} \left(\hat{x}\right)\right|}_{2} \qquad \text{(5)}$$

$${L}_{a d c o n} = - {E}_{x \sim {p}_{x}} {\left|\hat{x} - G \left(\hat{x}\right)\right|}_{1} \qquad \text{(6)}$$

$${L}_{n} = {λ}_{a d v} {L}_{a d v} + {λ}_{c o n} {L}_{c o n} + {λ}_{a d c o n} {L}_{a d c o n} + {λ}_{l a t} {L}_{l a t} \qquad \text{(7)}$$

It may be understood that in the process of training based on normal data items, x~pₓ in Equations (3) to (6) is xₙ~p_{xₙ}. In Equations (3) to (7), Z represents random noise input into the discriminative sub-model D, and λ_{con}, λ_{adcon}, λ_{adv} and λₗₐₜ are coefficients corresponding to the contextual loss function L_{con}, the contextual adversarial loss function L_{adcon}, the adversarial loss function L_{adv}, and the latent loss function Lₗₐₜ.

It may be appreciated that in Equation (6), the training objective is represented by a minus sign (i.e., “-”). Referring to FIG. 3, the training target is to expect that the reconstruction of the reconstructed data item 320 by the generative sub-model G fails, that is, the first output data item 330 does not have appropriate contextual information.

As another example, in the training process of the present disclosure it is expected that the difference between the reconstructed data item 320 and the normal data item 310 should be as small as possible, whereas the difference between the first output data item 330 and the reconstructed data item 320 should be as large as possible.

For example, the difference between the reconstructed data item 320 and the normal data item 310 may be smaller than a first threshold, and the difference between the first output data item 330 and the reconstructed data item 320 may be greater than a second threshold. Exemplarily, the difference may be represented as a distance, for example, the data item is an image type, and the difference may be a Euclidean distance between two images, etc. Optionally, the second threshold is greater than the first threshold, for example, the second threshold may be a predetermined multiple of the first threshold, such as 10 times, 100 times or other values.

In this way, referring to the process described with reference to FIG. 3, the training of the anomaly detection model may be achieved in an unsupervised manner based on the normal data items.

Optionally, in some embodiments of the present disclosure, the anomaly detection model may be further trained based on the set (Xₐ) of anomalous data items. Specifically, the anomalous data items in the training set may be input into the generative sub-model to obtain the second output data item; the anomalous detection model is trained based on a second loss function, where the second loss function comprises a third sub-function, the training objective of the third sub-function is consistent with the training objective of the second sub-function, and the third sub-function is obtained based on a difference between the second output data item and the anomalous data item.

Exemplarily, the third sub-function may be obtained based on the difference between the second output data item and the anomalous data item, for example, the third sub-function is denoted as F_{dist}(Xₐ, G(Xₐ)). Based on the above description about the second sub-function, in the training process, the third sub-function is also expected to be maximum (max), and the hyperparameters in the model may be obtained by learning on the basis of the training objective, as shown in the following Equations (8) and (9):

$$max {F}_{d i s t} \left({X}_{a} , G \left({X}_{a}\right) ; {θ}_{G}\right) \qquad \text{(8)}$$

$${max}_{D} \left[log \left(1 - D \left({X}_{a} ; {θ}_{D}\right)\right)\right] \qquad \text{(9)}$$

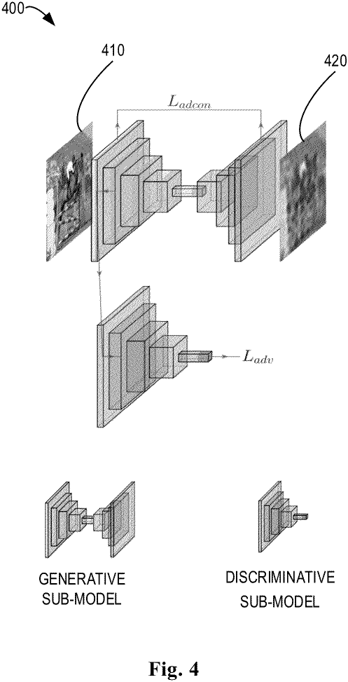

FIG. 4 illustrates a schematic diagram of a training process 400 based on anomalous data items according to embodiments of the present disclosure.

As shown in FIG. 4, an anomalous data item 410 is input into the generative sub-model to obtain a second output data item 420. For illustration, the type of the anomalous data item 410 shown in FIG. 4 is an image, and correspondingly, the second output data item 420 is also an image. However, it should be appreciated that the images shown in FIG. 4 are for illustration only, and the present disclosure is not limited thereto.

Optionally, the generative sub-model may include an encoder and a decoder. As shown in FIG. 4, the anomalous data item 410 is input into the encoder, an output of the encoder is input into the decoder, and an output of the decoder is the second output data item 420. However, it should be appreciated that on the basis of data reconstruction, the generative sub-model may have other structures, and the present disclosure does not limit the structure of the generative sub-model.

The anomaly detection model may be trained based on the training set of anomalous data items and based on the second loss function, for example, the second loss function may be represented as Lₐ. Exemplarily, a contextual adversarial loss function may be determined based on the third sub-function, and denoted as L_{adcon}, as shown in the above Equation (6).

Exemplarily, the second loss function Lₐ may be represented as a weighted sum of the contextual adversarial loss function L_{adcon}, the adversarial loss function L_{adv}, and the latent loss function Lₗₐₜ, as shown in the following Equation (10):

$${L}_{a} = \frac{{λ}_{a d v}}{{L}_{a d v}} + \frac{{λ}_{a d c o n}}{- {L}_{a d c o n}} + \frac{{λ}_{l a t}}{{L}_{l a t}} \qquad \text{(10)}$$

Furthermore, it may be appreciated that in the training process based on the anomalous data items, x~pₓ in Equations (4) to (6) is xₐ~p_{xₐ}.

In this way, the training of the anomaly detection model may be implemented in a supervised manner based on the anomalous data items, with reference to the process described in FIG. 4.

It should be appreciated that the loss functions shown in the above Equations (3) to (7) and Equation (10) are only illustrative, and in practical applications, various modifications may be made to the expression of the loss function. For example, Equation (6) may be expressed as W(d(X)), X represents the input data of the generative sub-model G, d(X) represents a distance between the output and the input of the generative sub-model G, and satisfies that the larger the d(X) is, the smaller the W(d(X)) is. Optionally, the distance between the output and input of the generative sub-model G may be expressed as the an L1 distance in Equation (6), or as a higher-order distance, or as a Structure Similarity Index Measure (SSIM). This is not limited in the present disclosure.

Exemplarily, the above first loss function for normal data items and the second loss function for anomalous data items may be collectively represented as a total loss function L, represented as the following Equation (11):

$$L = y {L}_{a} + \left(1 - y\right) {L}_{n} \qquad \text{(11)}$$

In Equation (11), y is a coefficient, and y ∈ 0,1. It may be understood that if the input data item is a normal data item, then y=0; otherwise, y = 1.

As an illustration, Table 1 below shows a computer pseudocode for training the anomaly detection model 130.

TABLE 1

Algorithm: 1 Training of AGAD
Requires S: a set of images with normal Sₐ and abnormal SIᵢ: a model parametrized by θ, & threshold to reset θₐ learning rate.

Ensures Anormaly detection model fₐ
1: repeat
2: Read mini-batch B =(x₁,x₂, xₘ)
3. x̂̅ = G(x), = D(x) {Reconstruct input}
4. x̂̅ = G(x̂), = D(x̂̅) {Reconstract recoonstructed input}
5: if x ∈ δₙ then
6: L_{g} = λ_{adv}L_{adv}(ŷ,1) + λ
7:. L_{g} = L_{adv}(ŷ,0) +L_{adv}(ŷ,1)
8: else if x ∈ δₙ then
9: L_{g} = λ_{adv}/Lₐ_{d}ᵥ(ŷ,0) - λ_{adcon}/L_{adcon}(x̂,x̂¹) + λₗₐₜ/Lₗₐₜ(x,)a
10: L_{d} = L_{adv}(y,0)
11: end if
12: θ_{g} ⇐ θₙ - ηΔ₀, L_{g} {Update NetG by stochastic gradient}
13: θ_{d} ⇐ θₙ - ηΔ₀, L_{d} {Update NetD by stochastic gradient}
14: until training finished

In Table 1, the anomaly detection model is represented as f_{θ}, and Algorithm 1 for training the anomaly detection model is referred to as adversarial training of Adversarial Generative Anomaly Detection (AGAD).

In order to train, it is possible to first acquire a Require, comprising: a training set S, a model f_{θ} parameterized by θ, and a threshold δ used to reset the parameter θ_{d}, where the training set comprises a set Sₙ of normal data items and a set Sₐ of anomalous data items. Furthermore, it is assumed that the data items in the training set are all in an image format.

In the pseudocode of Table 1, rows 2 to 4 represent input data items and definitions of the data items at stages. Rows 5 to 8 represent the processing of normal data items, rows 9 to 12 represent the processing of anomalous data items, and rows 12 to 13 represent iteration of parameters. In this way, the supervision-based and semi-supervision-based anomaly detection solutions can be unified, so that fewer anomalous data items may be used to improve the performance of the anomaly detection model.

In this way, in the embodiments of the present disclosure, the anomaly detection model may be obtained based on the set of normal data items and/or the set of anomalous data items.

In this way, the trained anomaly detection model is obtained through training in the embodiments of the present disclosure. Furthermore, during training, it is possible to reconstruct again by using the reconstructed data items generated from the normal data items and by considering pseudo-anomaly features of the reconstructed data items, to try to make re-reconstruction fail. In this way, the training process can learn contextual adversarial information, so that the trained anomaly detection model has a higher precision and a higher recall rate.

In this way, in the training process in the embodiments of the present disclosure, the contextual adversarial information (e.g., L_{adv}) is introduced to generate pseudo-anomaly data in an adversarial manner, and thereby better learn discriminant features between the normal data items and anomalous data items. The anomaly detection model with higher model performance can be effectively obtained even when the anomalous data items do not exceed 5%.

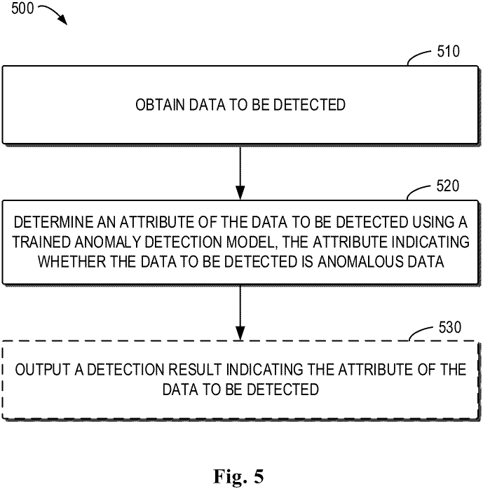

An example training process for the anomaly detection model 130 is described above with reference to FIG. 2 through FIG. 4. Whether the data input into the model is anomalous data can be detected more accurately through the trained anomaly detection model 130. Hereinafter, a schematic usage process of the anomaly detection model 130 will be described with reference to FIG. 5.

FIG. 5 illustrates a flowchart of an example usage process 500 according to embodiments of the present disclosure. For example, the method 500 may be performed by the computing device 110 as shown in FIG. 1. It should be understood that the method 500 may also include additional blocks not shown and/or some blocks shown may be omitted. The scope of the present disclosure is not limited in this respect.

At block 510, data to be detected is obtained.

At block 520, an attribute of the data to be detected is determined using the trained anomaly detection model, the attribute indicates whether the data to be detected is anomalous data.

Optionally, as shown in FIG. 5, the method may further comprise: outputting a detection result at block 530, where the detection result indicates the attribute of the data to be detected.

In the embodiments of the present disclosure, the data to be detected may be input by a user, or may be acquired from a storage device. The data to be detected may belong to any of the following categories: audio data, ECG data, EEG data, image data, video data, point cloud data, or volume data. Optionally, the volume data may be, for example, CT data or OCT data.

It may be appreciated that the trained anomaly detection model may be obtained by training through the training process as shown in FIG. 2 through FIG. 4. Furthermore, it may be understood that the types of the data items in the training set for training the anomaly detection model are the same as the types of the data to be detected.

Exemplarily, at block 520, a score value of the data to be detected may be obtained by using the trained anomaly detection model; and furthermore, the attribute of the data to be detected is determined based on the score value. Specifically, the score value may represent a difference between data obtained by the anomaly detection model by reconstructing the data to be detected and the data to be detected. Then if the score value is not higher than (that is, less than or equal to) a preset threshold, a first attribute of the data to be detected is determined, the first attribute indicates that the data to be detected is normal data. If the score value is higher than the preset threshold, a second attribute of the data to be detected is determined, the second attribute indicates that the data to be detected is anomalous data.

The preset threshold may be preset based on at least one of the following factors: detection accuracy, data type, and the like.

Optionally, in some examples, the detection result may comprise the score value, thereby indirectly indicating the attribute of the data to be detected. In some examples, the detection result may comprise indication information indicating whether the data to be detected is anomalous data.

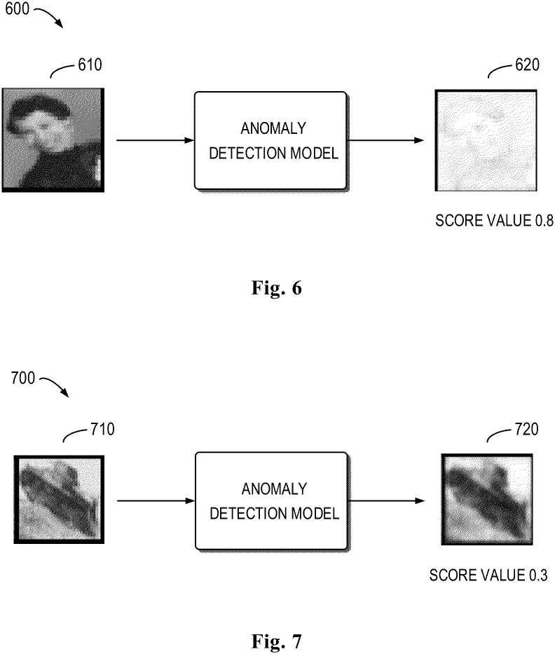

FIG. 6 illustrates a schematic diagram of a result 600 of anomaly detection according to embodiments of the present disclosure. As shown in FIG. 6, it is assumed that the reconstructed data 620 may be obtained by inputting the data to be detected 610 into the trained anomaly detection model, and the score value is 0.8. If the preset threshold is equal to 0.7, it may be determined that the data to be detected 610 is anomalous data.

FIG. 7 illustrates a schematic diagram of a result 700 of anomaly detection according to embodiments of the present disclosure. As shown in FIG. 7, it is assumed that the reconstructed data 720 may be obtained by inputting the data to be detected 710 into the trained anomaly detection model, and the score value is 0.3. If the preset threshold is equal to 0.7, it may be determined that the data to be detected 710 is normal data.

In addition, the solution provided by the embodiments of the present disclosure has significant advantages over existing anomaly detection models. For example, it is assumed that AnoGAN is compared with the solution provided by the embodiments of the present disclosure based on a public data set MNIST. Taking an Area Under the Curve (AUC) as a comparative measure, an average AUC obtained by AnoGAN is 93.7%, while the average AUC obtained by the solution provided by the embodiments of the present disclosure is 99.1%. It may be seen that the solution provided by the embodiments of the present disclosure can achieve a better result.

In some embodiments, a computing device comprises a circuit configured to perform the following operations: obtaining data to be detected; and determining an attribute of the data to be detected using a trained anomaly detection model, the attribute indicating whether the data to be detected is anomalous data, wherein the anomaly detection model is trained based on a difference between a reconstructed data item and a normal data item and a difference between a first output data item and the reconstructed data item, wherein during training, the normal data item is input into a generative sub-model of the anomaly detection model to obtain the reconstructed data item, and the reconstructed data item is input into the generative sub-model to obtain the first output data item.

In some embodiments, the anomaly detection model is trained based on a first loss function, wherein the first loss function is constructed based on the difference between the reconstructed data item and the normal data item and the difference between the first output data item and the reconstructed data item, wherein the first loss function comprises a first sub-function and a second sub-function, the first sub-function is obtained based on the difference between the reconstructed data item and the normal data item, and the second sub-function is obtained based on the difference between the first output data item and the reconstructed data item, wherein training objectives of the first sub-function and the second sub-function are opposite.

In some embodiments, the anomaly detection model is further trained based on a second loss function, wherein the second loss function comprises a third sub-function, a training objective of the third sub-function is consistent with a training objective of the second sub-function, the third sub-function is obtained based on a difference between a second output data item and an anomalous data item in the training set, and the second output data item is obtained by inputting the anomalous data item in the training set into the generative sub-model.

In some embodiments, the trained anomaly detection model further comprises a discriminative sub-model for determining whether the reconstructed data item is true or false.

In some embodiments, the computing device comprises a circuit configured to perform the following operations: determining a score value of the data to be detected by using the trained anomaly detection model, the score value representing a difference between data obtained by the anomaly detection model by reconstructing the data to be detected and the data to be detected; if the score value is not higher than a preset threshold, determining a first attribute of the data to be detected, the first attribute indicating that the data to be detected is normal data; if the score value is higher than the preset threshold, determining a second attribute of the data to be detected, the second attribute indicating that the data to be detected is anomalous data.

In some embodiments, the data to be detected belongs to any of the following categories: audio data, electrocardiogram data, electroencephalogram data, image data, video data, point cloud data, or volume data.

In some embodiments, the computing device comprises a circuit configured to perform the following operations: inputting a normal data item in the training set into a generative sub-model of the anomaly detection model to obtain a reconstructed data item; inputting the reconstructed data item into the generative sub-model to obtain a first output data item; and training the anomaly detection model based on a difference between the reconstructed data item and the normal data item and a difference between the first output data item and the reconstructed data item.

In some embodiments, the computing device comprises a circuit configured to perform the following operations: constructing a first loss function based on the difference between the reconstructed data item and the normal data item and the difference between the first output data item and the reconstructed data item, wherein the first loss function comprises a first sub-function and a second sub-function, the first sub-function is obtained based on the difference between the reconstructed data item and the normal data item, and the second sub-function is obtained based on the difference between the first output data item and the reconstructed data item; and training the anomaly detection model based on the first loss function, wherein training objectives of the first sub-function and the second sub-function are opposite.

In some embodiments, the difference between the reconstructed data item and the normal data item is smaller than a first threshold, and the difference between the first output data item and the reconstructed data item is larger than a second threshold.

In some embodiments, the computing device comprises a circuit configured to perform the following operations: inputting the anomalous data item in the training set into a generative sub-model to obtain a second output data item; and training an anomaly detection model based on a second loss function, wherein the second loss function comprises a third sub-function, a training objective of the third sub-function is consistent with a training objective of the second sub-function, and the third sub-function is obtained based on a difference between the second output data item and the anomalous data item.

In some embodiments, the anomaly detection model further comprises a discriminative sub-model for determining whether the reconstructed data item is true or false.

In some embodiments, the computing device comprises a circuit configured to perform the following operation: training the generative sub-model and the discriminative sub-model in an adversarial manner based on the first loss function.

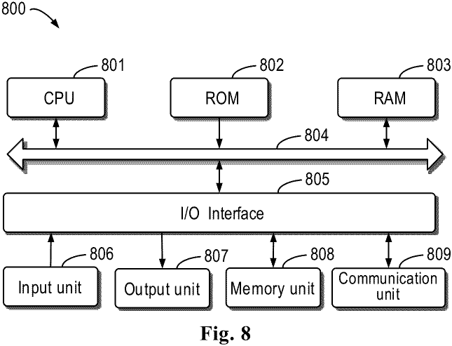

FIG. 8 illustrates a schematic block diagram of an example device 800 that is suitable for implementing embodiments of the present disclosure. For example, the computing device 110 as shown in FIG. 1 may be implemented by the device 800. As illustrated therein, the device 800 includes a central processing unit (CPU) 801 that may perform various appropriate actions and processing based on computer program instructions stored in a Read-Only Memory (ROM) 802 or loaded from a memory unit 808 to a Random-Access Memory (RAM) 803. In the RAM 803, there may further store various programs and data needed for operations of the device 800. The CPU 801, ROM 802 and RAM 803 are connected to each other via a bus 804. An input/output (I/O) interface 805 is also connected to the bus 804.

Various components in the device 800 are connected to the I/O interface 805, including: an input unit 806 such as a keyboard, a mouse and the like; an output unit 807 such as various types of displays and loudspeakers, etc.; a memory unit 808 such as a magnetic disk, an optical disk, and etc.; and a communication unit 809 such as a network card, a modem, and a wireless communication transceiver, etc. The communication unit 809 allows the device 800 to exchange information/ data with other devices via a computer network such as the Internet and/or various types of telecommunications networks. It is understood that the present disclosure may display, via the output unit 807, real-time dynamic change information of the customer satisfaction, key factor identification information of a group of customers or individual customers subjected to the satisfaction, optimized strategy information, and strategy implementation effect assessment information, etc.

The processing unit 801 may be implemented by one or more processing circuits. The processing unit 801 may be configured to perform various processes and processing described above. For example, in some embodiments, the process described above may be implemented as a computer software program that is tangibly embodied on a machine readable medium, e.g., the memory unit 808. In some embodiments, part or all of the computer program may be loaded and/or mounted onto the device 800 via ROM 802 and/or communication unit 809. When the computer program is loaded to the RAM 803 and executed by the CPU 801, one or more steps of the process as described above may be executed.

The present disclosure may be implemented a system, a method and/or a computer program product. The computer program product may comprise a computer-readable storage medium on which computer-readable program instructions for executing various aspects of the present disclosure are loaded.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium comprises the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform various aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processing unit of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the drawings illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It is also to be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to optimal explain the principles of the embodiments, the practical application or technical improvement over technologies found in the marketplace, or to enable others of ordinary skill in the art to understand the embodiments disclosed herein.

I/We claim:

1. A data processing method, comprising:
obtaining data to be detected; and
determining an attribute of the data to be detected using a trained anomaly detection model, the attribute indicating whether the data to be detected is anomalous data,
wherein the anomaly detection model is trained based on a difference between a reconstructed data item and a normal data item and a difference between a first output data item and the reconstructed data item, wherein during training, the normal data item is input into a generative sub-model of the anomaly detection model to obtain the reconstructed data item, and the reconstructed data item is input into the generative sub-model to obtain the first output data item.

2. The method according to claim 1, wherein the anomaly detection model is trained based on a first loss function, wherein the first loss function is constructed based on the difference between the reconstructed data item and the normal data item and the difference between the first output data item and the reconstructed data item, the first loss function comprises a first sub-function and a second sub-function, the first sub-function is obtained based on the difference between the reconstructed data item and the normal data item, and the second sub-function is obtained based on the difference between the first output data item and the reconstructed data item, wherein training objectives of the first sub-function and the second sub-function are opposite.

3. The method according to claim 2, wherein the anomaly detection model is further trained based on a second loss function, wherein the second loss function comprises a third sub-function, a training objective of the third sub-function is consistent with a training objective of the second sub-function, the third sub-function is obtained based on a difference between a second output data item and an anomalous data item in a training set, and the second output data item is obtained by inputting the anomalous data item in the training set into the generative sub-model.

4. The method according to claim 1, wherein the trained anomaly detection model further comprises a discriminative sub-model for determining whether the reconstructed data item is true or false.

5. The method according to claim 4, wherein the trained anomaly detection model is obtained by training the generative sub-model and the discriminative sub-model in an adversarial manner.

6. The method according to claim 1, wherein the determining the attribute of the data to be detected comprises:
determining a score value of the data to be detected by using the trained anomaly detection model, the score value representing a difference between data obtained by the anomaly detection model by reconstructing the data to be detected and the data to be detected;
if the score value is not higher than a preset threshold, determining a first attribute of the data to be detected, the first attribute indicating that the data to be detected is normal data;
if the score value is higher than the preset threshold, determining a second attribute of the data to be detected, the second attribute indicating that the data to be detected is anomalous data.

7. The method according to claim 1, wherein the data to be detected belongs to any of the following categories: audio data, electrocardiogram data, electroencephalogram data, image data, video data, point cloud data, or volume data.

8. A method of training an anomaly detection model, comprising:
inputting a normal data item in a training set into a generative sub-model of the anomaly detection model to obtain a reconstructed data item;
inputting the reconstructed data item into the generative sub-model to obtain a first output data item; and
training the anomaly detection model based on a difference between the reconstructed data item and the normal data item and a difference between the first output data item and the reconstructed data item.

9. The method according to claim 8, wherein the training the anomaly detection model based on a difference between the reconstructed data item and the normal data item and a difference between the first output data item and the reconstructed data item comprises:
constructing a first loss function based on the difference between the reconstructed data item and the normal data item and the difference between the first output data item and the reconstructed data item, wherein the first loss function comprises a first sub-function and a second sub-function, the first sub-function is obtained based on the difference between the reconstructed data item and the normal data item, and the second sub-function is obtained based on the difference between the first output data item and the reconstructed data item; and
training the anomaly detection model based on the first loss function, wherein training objectives of the first sub-function and the second sub-function are opposite.

10. The method according to claim 8, wherein the difference between the reconstructed data item and the normal data item is smaller than a first threshold, and the difference between the first output data item and the reconstructed data item is larger than a second threshold.

11. The method according to claim 9, further comprising:
inputting the anomalous data item in the training set into the generative sub-model to obtain a second output data item;
training the anomaly detection model based on a second loss function, wherein the second loss function comprises a third sub-function, a training objective of the third sub-function is consistent with a training objective of the second sub-function, and the third sub-function is obtained based on a difference between the second output data item and the anomalous data item.

12. The method according to claim 8, wherein the anomaly detection model further comprises a discriminative sub-model for determining whether the reconstructed data item is true or false.

13. A computer readable storage medium having machine-executable instructions stored thereon, the machine-executable instructions, when executed by a device, cause the device to perform:
obtaining data to be detected; and
determining an attribute of the data to be detected using a trained anomaly detection model, the attribute indicating whether the data to be detected is anomalous data,
wherein the anomaly detection model is trained based on a difference between a reconstructed data item and a normal data item and a difference between a first output data item and the reconstructed data item, wherein during training, the normal data item is input into a generative sub-model of the anomaly detection model to obtain the reconstructed data item, and the reconstructed data item is input into the generative sub-model to obtain the first output data item.

14. The computer readable storage medium according to claim 13, wherein the anomaly detection model is trained based on a first loss function, wherein the first loss function is constructed based on the difference between the reconstructed data item and the normal data item and the difference between the first output data item and the reconstructed data item, the first loss function comprises a first sub-function and a second sub-function, the first sub-function is obtained based on the difference between the reconstructed data item and the normal data item, and the second sub-function is obtained based on the difference between the first output data item and the reconstructed data item, wherein training objectives of the first sub-function and the second sub-function are opposite.

15. The computer readable storage medium according to claim 14, wherein the anomaly detection model is further trained based on a second loss function, wherein the second loss function comprises a third sub-function, a training objective of the third sub-function is consistent with a training objective of the second sub-function, the third sub-function is obtained based on a difference between a second output data item and an anomalous data item in a training set, and the second output data item is obtained by inputting the anomalous data item in the training set into the generative sub-model.

16. The computer readable storage medium according to claim 14, wherein the difference between the reconstructed data item and the normal data item is smaller than a first threshold, and the difference between the first output data item and the reconstructed data item is larger than a second threshold.

17. The computer readable storage medium according to claim 13, wherein the trained anomaly detection model further comprises a discriminative sub-model for determining whether the reconstructed data item is true or false.

18. The computer readable storage medium according to claim 17, wherein the trained anomaly detection model is obtained by training the generative sub-model and the discriminative sub-model in an adversarial manner.

19. The computer readable storage medium according to claim 13, wherein the device is caused to perform:
determining a score value of the data to be detected by using the trained anomaly detection model, the score value representing a difference between data obtained by the anomaly detection model by reconstructing the data to be detected and the data to be detected;
if the score value is not higher than a preset threshold, determining a first attribute of the data to be detected, the first attribute indicating that the data to be detected is normal data;
if the score value is higher than the preset threshold, determining a second attribute of the data to be detected, the second attribute indicating that the data to be detected is anomalous data.

20. The computer readable storage medium according to claim 13, wherein the data to be detected belongs to any of the following categories: audio data, electrocardiogram data, electroencephalogram data, image data, video data, point cloud data, or volume data.
